(19) United States
(12) Patent Application Publication
(10) Pub. No.: US 2022/0242608 A1
(43) Pub. Date: Aug. 4, 2022

(54) One-Piece, Plastic-Free Blister Package And Method

(71) Applicant: Robert Green, San Diego, CA (US)

(72) Inventor: Robert Green, San Diego, CA (US)

(21) Appl. No.: 17/590,159

(22) Filed: Feb. 1, 2022

Related U.S. Application Data
(60) Provisional application No. 63/145,318, filed on Feb. 3, 2021.

(51) Int. Cl. B65D 5/20; B65B 43/50; B65B 7/28; B65B 43/56; B65D 73/00

(52) U.S. Cl. CPC B65D 5/2047; B65B 43/50; B65D 73/0057; B65B 43/56; B65B 7/2878

(57) ABSTRACT

A one-piece, plastic-free blister package is disclosed. The package is formed from a one-piece card comprising a front support card having a window and a rear portion. The rear portion comprises a plurality of sidewalls and a plurality of tabs which can be folded to form a cavity to hold a small product. The package is then assembled by bonding part of the rear portion to the front support card through the application of heat and pressure. The package encloses the product, which is visible to consumers through the window cut on the front support card.

### RELATED APPLICATION INFORMATION

The present application claims priority under 35 U.S.C. Section 119(e) to U.S. Provisional Patent Application Ser. No. 63/145,318 filed Feb. 3, 2021 entitled “One-piece, Plastic-free Blister Package and Method” the disclosure of which is incorporated herein by reference in its entirety.

### BACKGROUND OF THE INVENTION

### 1. Field of the Invention

The present invention relates in general to blister packaging. In particular, the invention is directed to a one-piece, plastic-free blister packaging for enclosing products.

### 2. Description of the Related Art

Blister packaging is used for packaging many small consumer products. Most conventional blister packaging relies on a clear plastic cover to allow consumers to see the product enclosed by the blister packaging. However, many consumers are aware of the effect of “plastic pollution” as plastics are known to degrade very slowly and may impact the environment for many years.

Accordingly, a need exists to provide plastic-free blister packaging.

### SUMMARY OF THE INVENTION

In the first aspect, a one-piece, plastic-free blister package is disclosed. The package comprises a one-piece card which comprises a front support card, and a rear portion retained to the front support card. The rear portion is configured for folding about and enclosing a product. The rear portion comprises a rectangular back, a plurality of sidewalls foldably connected to and emerging away from the rectangular back portion, the plurality of sidewalls configured for offsetting the back portion from the front support card when folded, and a plurality of tabs, each of the plurality of tabs foldably connected to and emerging away from a corresponding sidewall of the plurality of sidewalls.

In a first preferred embodiment, the one-piece card is coated with blister coating. The blister coating is preferably applied to a back surface of the one-piece card wherein the tabs of the rear portion are bonded to the front support card to form a cavity. The front support card preferably further comprises a window for displaying a product. The one-piece card preferably comprises cardstock in the range of approximately 14 point cardstock to approximately 28 point cardstock. The plurality of sidewalls is preferably foldably connected to the back by a plurality of fold lines. Each tab is preferably foldably connected to a corresponding sidewall by a plurality of fold lines. The fold lines preferably comprise one or more of a perforated line or a scored line. The package preferably has no plastic components. The one-piece card preferably has printing.

In a second aspect, a one-piece, plastic-free blister package is disclosed. The package comprises a one-piece card which further comprises a front support card, and a rear portion retained to the support card. The rear portion comprises a rectangular back, a first horizontal sidewall emerging vertically upward from the back, the first horizontal sidewall foldably connected to the back by a first horizontal foldable line and a second horizontal sidewall emerging vertically downward from the back, the second horizontal sidewall n foldably connected to the back by a second horizontal foldable line. The rear portion further comprises a first vertical sidewall emerging horizontally from the back toward the support card, the first vertical sidewall foldably connected to the back by a first vertical foldable line, and a second vertical sidewall emerging horizontally from the back in a direction away from the support card, the second vertical sidewall foldably connected to the back by a second vertical foldable line. The rear portion further comprises a first horizontal tab emerging vertically upward from the first horizontal sidewall, the first horizontal tab foldably connected to the first horizontal sidewall by a third horizontal foldable line, and a second horizontal tab emerging vertically downward from the second horizontal sidewall, the second horizontal tab foldably connected to the second horizontal sidewall by a fourth horizontal foldable line. The rear portion further comprises a first vertical tab foldably coupled to the first vertical sidewall and the support card, the first vertical tab foldably connected to the first vertical sidewall by a third vertical line, the first vertical tab foldably connected to the support card by a forth vertical fold line, and a second vertical tab emerging horizontally from the second vertical sidewall in a direction further away from the support card, the second vertical tab foldably connected to the second vertical sidewall by a fifth vertical foldable line.

In a second preferred embodiment, the one-piece card is coated with blister coating. The blister coating is preferably applied to a back surface of the one-piece card wherein the tabs of the rear portion is bonded to the front support card to form a cavity. The front support card preferably further comprises a window for displaying a product. The one-piece card preferably comprises cardstock in the range of approximately 14 point cardstock to approximately 28 point cardstock. The fold lines preferably comprise one or more of a perforated line or a scored line. The package preferably has no plastic components. The one-piece card preferably has printing.

In a third aspect, a method of making a one-piece, plastic-free package comprising a front support card and a rear portion, the rear portion comprising a back, a plurality of sidewalls, and a plurality of tabs is disclosed. The method comprises printing onto a card, applying a blister coating onto the card, and cutting the card to form a one-piece, plastic-free package. The method further comprises folding a rear portion of a package to form a cavity to receive a product, folding a front support card over the rear portion to form an enclosure for the package, and applying heat and pressure to the package for a specified time to bond a plurality of tabs of the rear portion to the front support card to form an assembled package.

In a third preferred embodiment, applying heat and pressure to the package with a specific sealing time to seal the tabs of the rear portion to the front support card further comprises applying the heat in the range of approximately 275 degrees to approximately 325 degrees Fahrenheit, applying pressure of in the range of approximately 70 pounds per square inch of pressure to approximately 120 pounds per square inch of pressure, and applying the heat and pressure to the package for a time in the range of approximately 3 seconds to approximately 6 seconds.

These and other features and advantages of the invention will become more apparent with a description of preferred embodiments in reference to the associated drawings.

### DESCRIPTION OF THE DRAWINGS

FIG. 1 is a view of the back surface of a one-piece, plastic-free package having a front support card and a rear portion for holding a product in an embodiment.

FIG. 2 is a view of the back surface of the one-piece, plastic-free package showing the rear portion folded to hold a package.

FIG. 3 is a cross-sectional view of the one-piece, plastic free package being formed in blister sealer.

FIG. 4 is a flowchart showing an exemplary method for fabricating one-piece, plastic-free packing.

FIG. 5 is a front view of a one-piece, plastic-free package showing the one-piece package after being die cut in an embodiment.

FIG. 6 is a rear view of a one-piece, plastic-free package showing the one-piece package after being die cut.

FIG. 7 is a rear view of a one-piece, plastic-free package showing the one-piece package after the rear portion is folded to form a cavity to hold a product.

FIG. 8 is a perspective view of a one-piece, plastic-free package showing the rear portion folding onto the front support card of the one-piece card.

FIG. 9 is a rear view of a one-piece, plastic-free package showing the rear portion positioned on top of the front support card of the one-piece card.

FIG. 10 is a perspective, rear view of the one-piece, plastic-free package showing the rear portion positioned on top of the front portion of the one-piece card.

FIG. 11 is a perspective, front view of the one-piece, plastic-free package showing the cavity for holding a product.

FIG. 12 is a perspective, rear view of the one-piece, plastic-free package fully assembled in an embodiment.

FIG. 13 is a perspective, front view of a one-piece, plastic-free package fully assembled in an embodiment.

FIG. 14 is a rear view of a one-piece, plastic-free package in an embodiment.

FIG. 15 is a perspective view of the one-piece, plastic-free package where the rear portion is folded to form a cavity to hold a product, and is being folded over to fold onto the front support card.

FIG. 16 is a rear view of the one-piece, plastic-free package showing an assembled package.

FIG. 17 is a front view of the one-piece, plastic-free package showing an assembled package.

### DETAILED DESCRIPTION OF THE PREFERRED EMBODIMENTS

In an embodiment, a one-piece, plastic-free blister package is contemplated. The package is formed from a one-piece card that may have printed graphics or text on the front and back surfaces of the one-piece card. A blister coating is applied to the back surface of the back side of the one-piece card. The one-piece card is die cut to form a front support card having an open window cut through the front support card and a rear portion connected to the front support card. The rear portion has a back, four sidewalls, and four tabs, so that when folded, a cavity is formed to hold a product. The cavity is sized and configured for holding products such as batteries, an essential oil container, cosmetics, or lip balm, for example. The assembled package is formed by simply folding the front support card over the rear portion folded to form a cavity. Heat and pressure are applied to the package which seals and bonds the front support card to the rear portion. The assembled package encloses the product, which is visible to consumers through the window cut on the front support card, and does not require plastic components such as a separate plastic cover for example.

Embodiments described herein may have several benefits over conventional packages and packaging methods. First, embodiments are free from the use of plastic components which are often used to showcase a product in conventional packaging. Many consumers are environmentally conscientious and may appreciate using plastic-free packaging which may be more advantageous to the environment. Second, embodiments having an open window in the front support card which enables the consumer to “touch and feel” the products they wish to purchase. Third, consumers may appreciate that the packaging encloses the product to prevent tampering with the product. Fourth, as the package is formed from a one-piece card, the package may be assembled with a simple “fold and seal” technique so that the front support card and the rear portion are self-aligned during the bonding process.

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a One-piece, Plastic-free Blister Package and Method.

The method involves using a blister packaging process to package a product within the package, wherein the package is made from cardboard or other non-plastic material. It is a single piece of card material with a fold between the front portion and the rear portion of the blister package card.

Cards are printed then coated with a blister coating on the back side. The cards are die cut with a fold configured to the product and the dimensions change for different size products. The card stock can be from 14 point to 28 point blister board depending on the weight of the product. The steps for sealing the one-piece package include placing the card onto a sealing tray on a heat sealer, placing the product in the cavity, folding the front support card over and sealing.

Embodiments described herein include a one-piece paper product that is simply folded over and sealed without need for a separate plastic blister. It can be used for things like batteries, essential oil containers, flea spray, lip balm, etc., in that a window that is slightly smaller than the cylindrical product can be punched out so that the potential buyer can see the product through the window.

Teachings related to systems and methods related to a blister sealer disclosed in U.S. Pat. No. 5,997,688, entitled “COLLAPSIBLE ROTARY BLISTER SEALER WITH IMPROVED HEATING PLATE ASSEMBLY” to Wawrzyniak filed Nov. 8, 1996, U.S. Pat. No. 6,287,414, entitled “COLLAPSIBLE ROTARY BLISTER SEALER WITH IMPROVED HEATING PLATE ASSEMBLY” to Green and Wawrzyniak, filed Aug. 23, 1999, and U.S. Pat. No. 6,716,305, entitled “COLLAPSIBLE ROTARY BLISTER SEALER WITH ROLLING HEATER COATING” filed Sep. 6, 2001, may be employed herein and the disclosures of which are incorporated herein by reference in its entirety.

Although embodiments described herein depict a blister coated card, other configurations are contemplated such embodiments relying on adhesives to form the assembled package for example. Several embodiments are disclosed herein, and it shall be understood that the specific labels discussed for package 101 are similarly number for packaging 301, 401, and 501. For example, labels 110, 310, 410, and 510 all refer to a front support card, labels 102, 302, 402, and 502 all refer to the rear portion, and so forth for the rest of the components identified in package 101.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

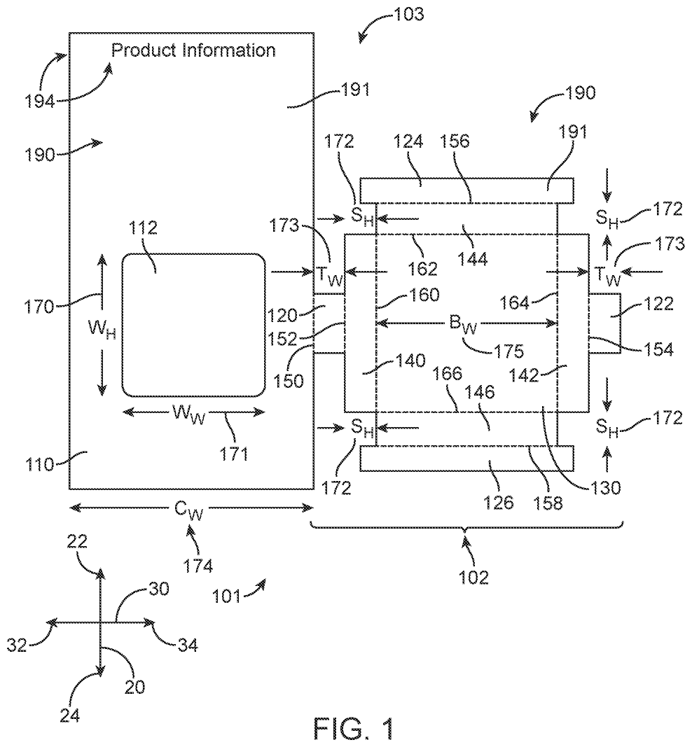

FIG. 1 is a view of the back surface 191 of a one-piece, plastic-free package 101 having a front support card 110 and a rear portion 102 for holding a product 10 in an embodiment. For reference, FIG. 1 also shows a vertical axis 20 indicting a vertically upward direction 22 and a vertically downward direction 24. A horizontal axis 30 shows a direction toward the right 34 (i.e., rightward direction, away from the support card 110) and a direction toward the left 32 (i.e., leftward direction, towards the support card 110).

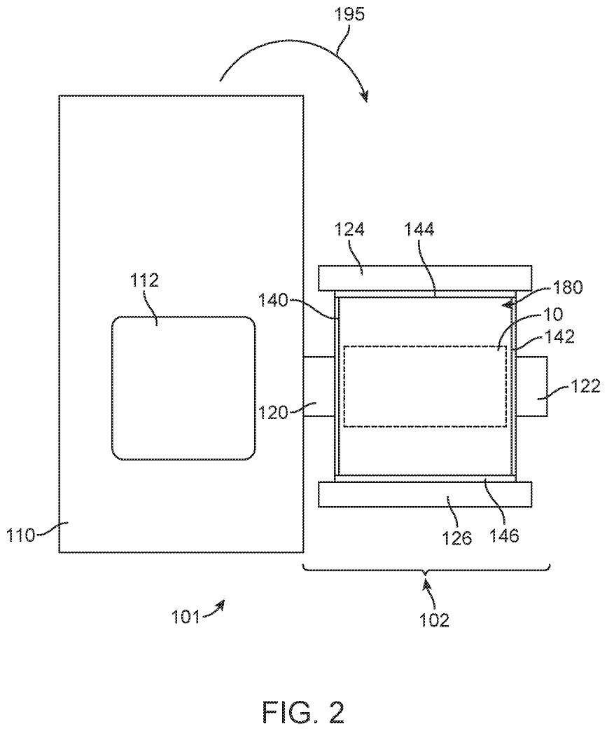

FIG. 1 depicts a one-piece, plastic-free blister package 101. The package 101 comprises a one-piece card 103 comprising a front support card 110 and a rear portion 102 retained to the front support card 110. The rear portion 102 is configured for folding about and enclosing a product 10 as seen in FIG. 2 and discussed below. The rear portion 102 comprises a rectangular back 130, a plurality of sidewalls 140, 142, 144, and 146 foldably connected to and emerging away from the rectangular back 130. The plurality of sidewalls 140, 142, 144, 146, and configured for offsetting the back 130 from the front support card 110 when folded. The package 101 further comprises a plurality of tabs 120, 122, 124, and 126 where each of the plurality of tabs 120, 122, 124, and 126 are foldably connected to and emerging away from a corresponding sidewall of the plurality of sidewalls 120, 122, 124, and 126 respectively. Specifically, tab 120 emerges away from the corresponding sidewall 140, tab 122 emerges away from the corresponding sidewall 142, tab 124 emerges away from the corresponding sidewall 144, and tab 126 emerges away from the corresponding sidewall 146.

In other words, FIG. 1 shows a one-piece, plastic-free blister package 101 comprising a one-piece card 103 comprising a front support card 110 and a rear portion 102 retained to the front support card 110. The rear portion 102 comprises a rectangular back 130, and a plurality of sidewalls 140, 142, 144, 146 and a plurality of tabs 120, 122, 124, and 126.

A first horizontal sidewall 144 emerges vertically upward from the back 130. The first horizontal sidewall 144 is foldably connected to the back 130 by a first horizontal foldable line 162. A second horizontal sidewall 146 emerges vertically downward from the back 130. The second horizontal sidewall 146 is foldably connected to the back 130 by a second horizontal foldable line 166.

A first vertical sidewall 140 emerges horizontally from the back 130 toward the support card 110 (i.e., leftward direction 32). The first vertical sidewall 140 is foldably connected to the back 130 by a first vertical foldable line 160. A second vertical sidewall 142 emerges horizontally from the back 130 in a direction away from the support card 110 (i.e., rightward direction 34). The second vertical sidewall 142 is foldably connected to the back 130 by a second vertical foldable line 164.

A first horizontal tab 124 emerges vertically upward from the first horizontal sidewall 144. The first horizontal tab 124 is foldably connected to the first horizontal sidewall 144 by a third horizontal foldable line 156. A second horizontal tab 126 emerges vertically downward from the second horizontal sidewall 146. The second horizontal tab 126 is foldably connected to the second horizontal sidewall 146 by a fourth horizontal foldable line 158.

A first vertical tab 120 is foldably coupled to the first vertical sidewall 140 and the support card 110. The first vertical tab 120 emerges away from in a leftward direction 32 and is foldably connected to the first vertical sidewall 140 by a third vertical line 152. The first vertical tab is foldably connected to the support card by a fourth vertical fold line 150. A second vertical tab 122 emerges horizontally from the second vertical sidewall 142 in a rightward direction 34 further away from the support card 110. The second vertical tab 122 is foldably connected to the second vertical sidewall 142 by a fifth vertical foldable line 154.

The front support card 110 has a window 112 having a window height W_{H} 170 and a window width of W_{W} 171. The sidewalls 140, 142, 144, and 146 are offset from the back section 130 by a dimension S_{H} 172. The tabs 120, 122, 124, and 126 have a width of Tw 173. The support card 110 has a width C_{W} 174. The window 112 may be positioned to be placed in the center of the support card 110 in a horizontal direction. The card width C_{W} 174 should be approximately the sum of twice the tab width T_{W} 173 and the width of the back B_{W}, corrected by the thickness of the one-piece card 103.

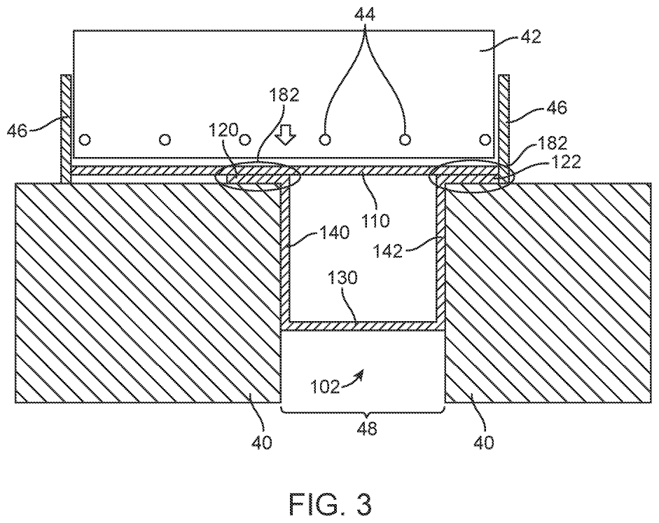

In a preferred embodiment, the one-piece card 103 comprises cardstock in the range of approximately 14 point cardstock to approximately 28 point cardstock. The one-piece card 103 may have printing 194 on one or both front 192 and back surfaces 191 of the one-piece card 103. The one-piece card 103 is coated with blister coating 194. In an embodiment, the blister coating 194 is applied to a back surface 191 of the one-piece card 103 wherein the tabs 120, 122, 124, and 126 of the rear portion 103 are bonded to the front support card 110 to form a cavity 180, as discussed below and illustrated in FIGS. 2 and 3. The plurality of sidewalls 140, 142, 144, and 146 are foldably connected to the back 130 by a plurality of fold lines 160, 162, 164, and 166. Each tab 120, 122, 124, and 126 is foldably connected to a corresponding sidewall 140, 142, 144, and 146 by a plurality of fold lines 152, 154, 156, and 158. The fold lines 150, 152, 154, 156, 160, 162, 164, and 166 comprises one or more of a perforated line or a scored line. The one-piece, plastic-free blister package 101 has no plastic components.

FIG. 2 is a view of the back surface 191 of the one-piece, plastic-free package 101 showing the rear portion 130 folded to form a cavity 180 which may hold a product 10. The cavity 180 is formed by folding each sidewall 140, 142, 144, and 146 ninety degrees with respect to the back 130. The tabs 120, 122, 124, and 126 are folded ninety degrees in an opposite direction so that the tabs 120, 122, 124, and 126 are parallel with the back 130. Once the product 10 is placed into the cavity 180, the front support card 110 is rotated as indicated by arrow 195 to fold over and align the front support cover 110 with the folded rear portion 102.

FIG. 3 is a cross-sectional view of a one-piece, plastic free package 101 being formed in blister sealer. The sidewalls 140 and 142 and the back 130 are inserted into an aperture 48 formed in a mounting plate 40. The front support card 110 and the rear portion 102 may be held in place with a series of alignment pins 46 configured to surround and align the components of the packaging 101. In an embodiment, the mounting plate 40 is individually shaped to receive one-piece packages of various sizes. The front card 110 is folded over to align with the rear portion 102. A heating plate assembly 42 having heating coils 44 is pressed down onto the one-piece plastic-free package 101, and applies heat and pressure to form a bond 182 between the front support card 110 and tabs 120, 122, 124, and 126. The bond 182 formed between the front support card 110 and the tabs 120, 122, 124, and 126 form a seal and hold the package 101 together.

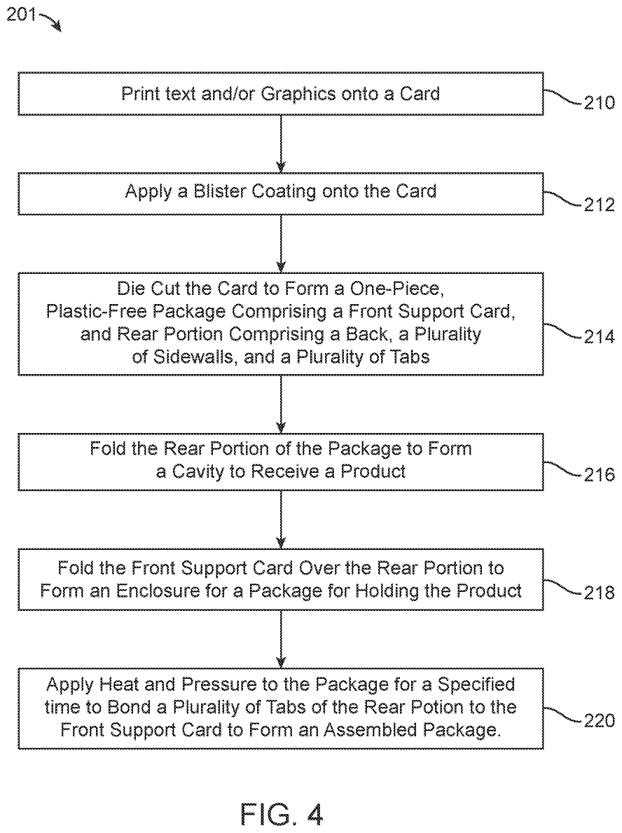

FIG. 4 is a flowchart 201 showing an exemplary method for fabricating one-piece, plastic-free packing 101. First, text and/or graphics are printed 194 onto the card 103 (step 210). A blister coating 190 is applied onto the card 103, preferably on the back surface 191 of the card 103 (step 212). Then the card 103 is cut, preferably with a die cutting process to form the plastic-free package 101 comprising a front support card 110, and the rear portion 102 comprising a back 130, a plurality of sidewalls 140, 142, 144, and 146 and a plurality of tabs 120, 122, 124, and 126 (step 214). The rear portion 102 is folded to form a cavity 180 to receive a product 10 (step 216). The front support card 110 is folded over the folded rear portion 102 to form an enclosure for holding the product 10 (step 218). Heat and pressure are applied to the package 101 to bond the plurality of tabs 120, 122, 124, and 126 to the front support card 110 to form an assembled package. After heat-pressing, the rear pocket is adhered to the front portion of the blister package card.

In a preferred embodiment, the front support card 110 is bonded and sealed to the rear portion 102 by applying heat in the range of approximately 275 degrees to approximately 325 degrees Fahrenheit, and applying pressure of in the range of approximately 70 pounds per square inch of pressure to approximately 120 pounds per square inch of pressure In an embodiment the application of heat and pressure is performed for a period of time in the range of approximately 3 seconds to approximately 6 seconds. The exact time for performing the sealing and bonding process will vary depending on the weight of the board.

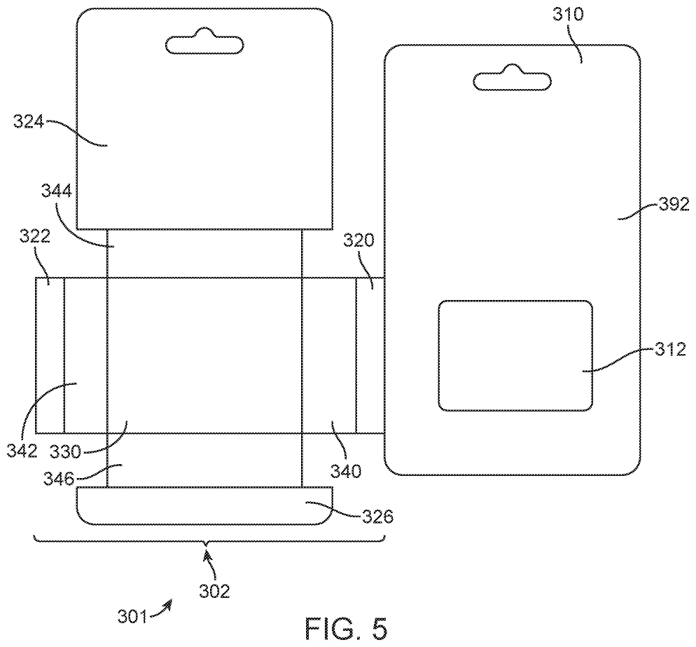

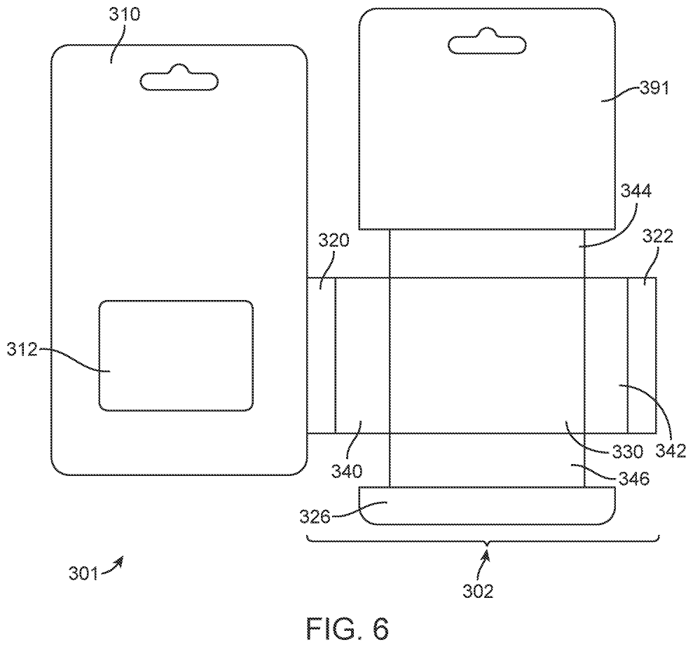

FIGS. 5-11 illustrate the fabrication process of forming an assembled one-piece, plastic-free package 301 in an embodiment. FIG. 5 is a front view of the front surface 392, and FIG. 6 is a rear view of the back surface 391 of the one-piece, plastic-free card 301 after being die cut in an embodiment. The one-piece plastic-free blister package 301 comprises a front support card 310 and a rear portion 302. The back 330 is surrounded by a plurality of sidewalls 340, 342, 344, and 346. Each of the sidewalls 340, 342, 344, and 346 is surrounded by a plurality of tabs 320, 322, 324, and 326. In an embodiment, tabs 326 and 324 are shaped to align with and cover the entire back surface 392 of the front support card 310. The front support card 310 has a cut-through window 312.

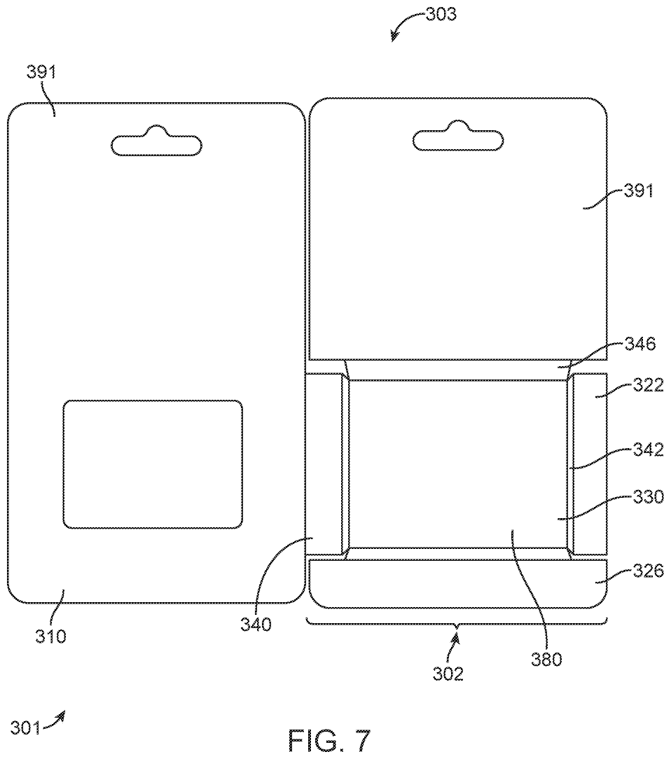

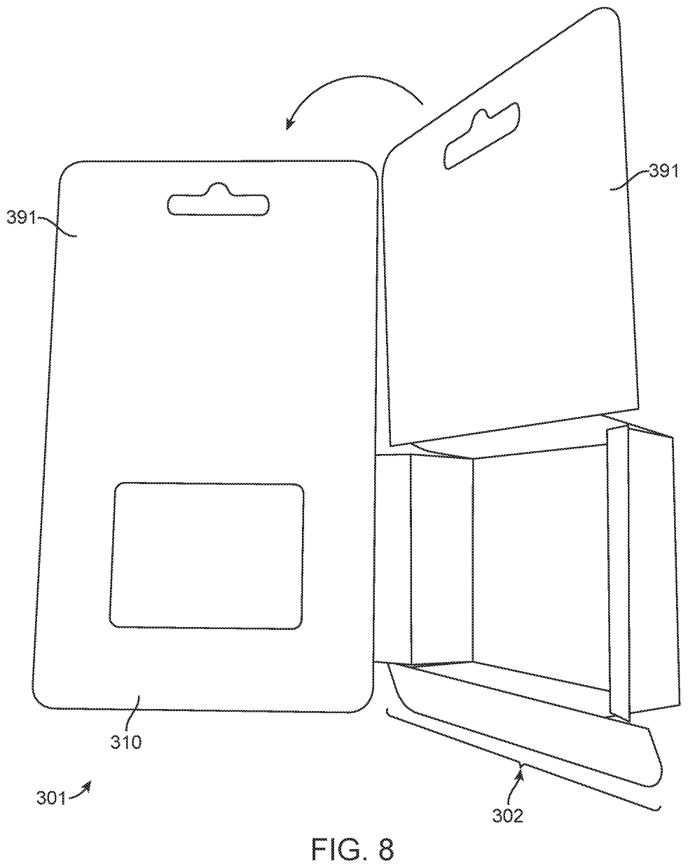

FIG. 7 is a perspective view of a back surface 391 of the one-piece, plastic-free package 301 showing the one-piece card 301 after the rear portion 302 is folded to form a cavity 380 to hold a product. FIG. 8 is a perspective view of the back surface 391 of a one-piece, plastic-free card 303 showing the rear portion folding 302 onto the front support card of the one-piece card 301.

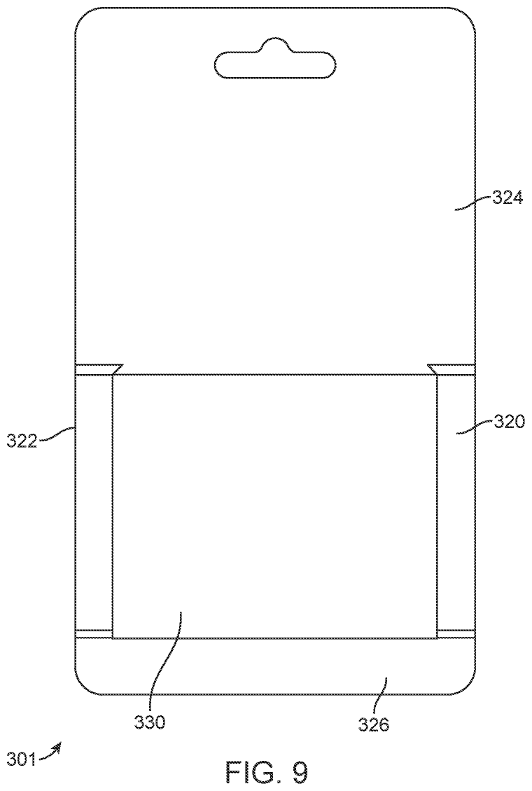

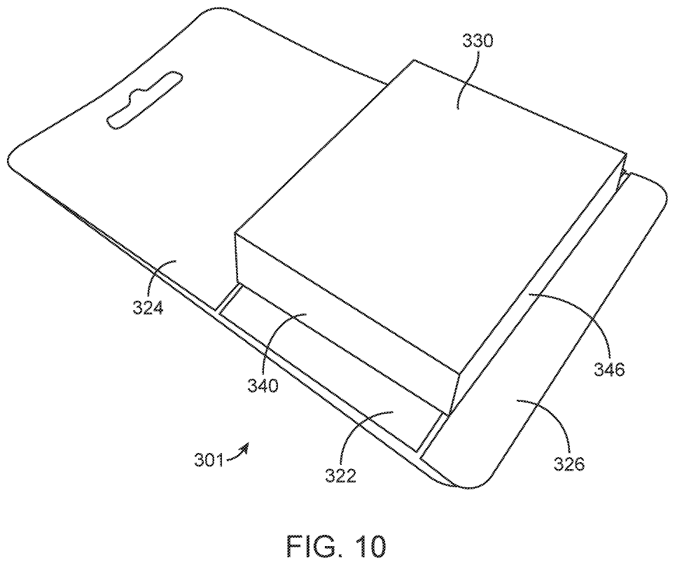

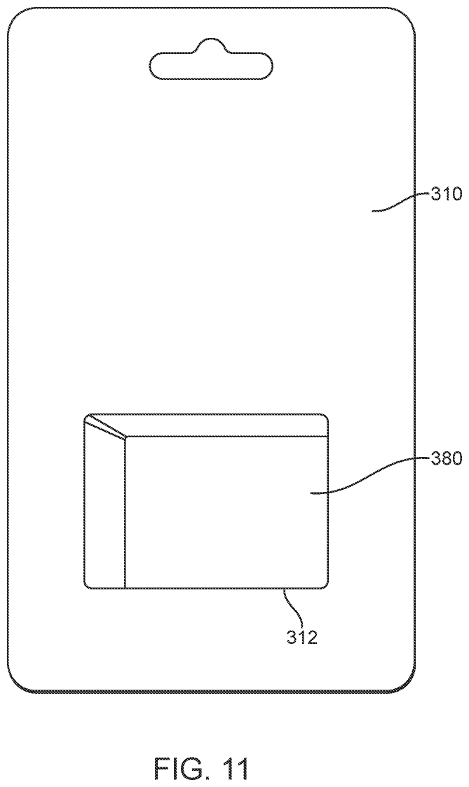

FIG. 9 is a rear view of a one-piece, plastic-free package 301 showing the rear portion 302 positioned on top of the front support card 310. FIG. 10 is a perspective, rear view of a one-piece, plastic-free card 303 showing the rear portion 302 positioned on top of the front support card 310. FIG. 11 is a perspective, front view of a one-piece, plastic-free card 301 showing the cavity 380 for holding a product (10) through the window 312. The packaged product is viewable in the front surface 392 of the blister package card 301.

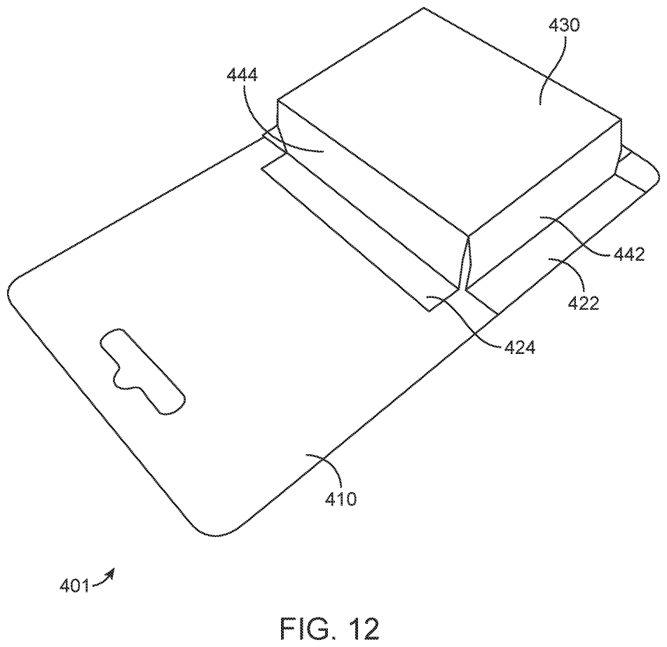

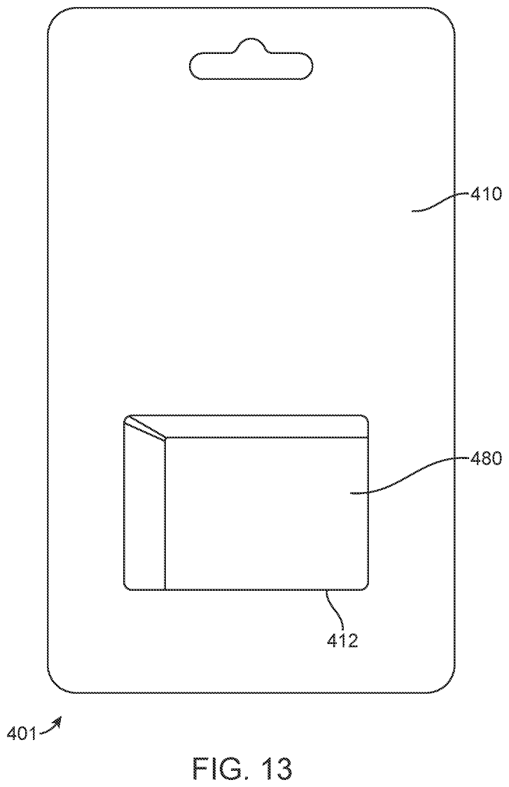

FIGS. 12-13 show an embodiment of the one-piece, plastic-free package 401. FIG. 12 is a perspective, rear view of a one-piece, plastic-free card 401 fully assembled in an embodiment. FIG. 12 shows the front support card 410, the back 430, the sidewalls 442 and 444, and the tabs 422 and 424. In an embodiment, the first horizontal tab 424 is not shaped to fully cover the font support card 410. FIG. 13 is a perspective, front view of a one-piece, plastic-free card 401 fully assembled in an embodiment. The cavity 480 is viewable through the window 480 cut into the front surface of the front support card 410.

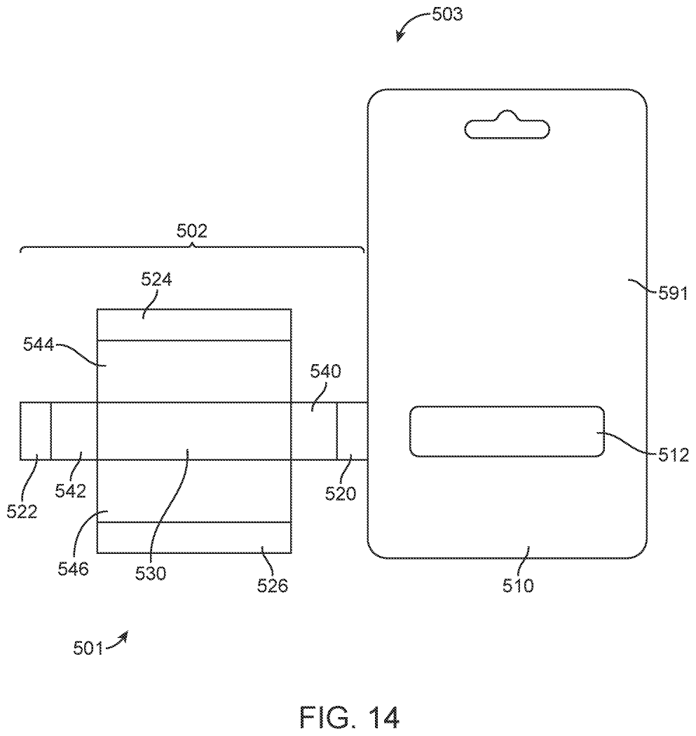

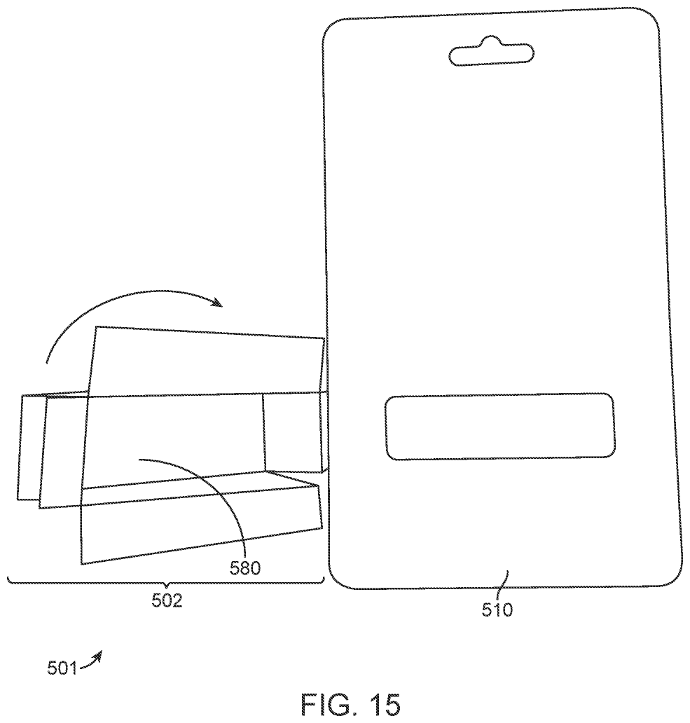

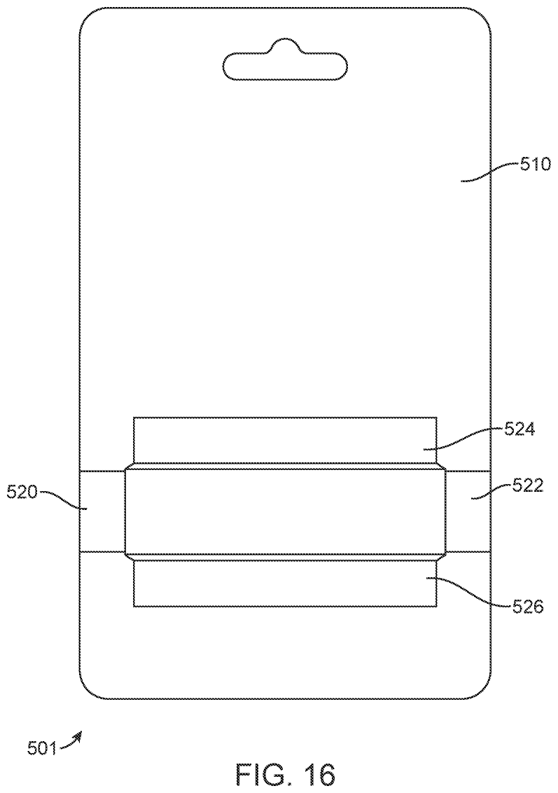

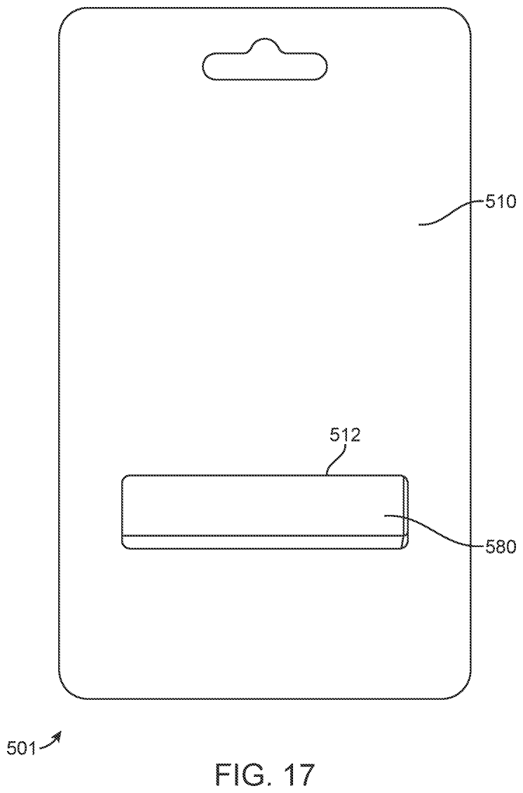

FIGS. 14-17 show an embodiment of the one-piece, plastic-free package 501. FIG. 14 is a rear view of a one-piece, plastic-free package 501 in an embodiment. The one-piece, plastic-free package 501 comprises a front support card 510 and a rear portion 502. The rear portion 502 comprises a back 530, a plurality of sidewall 540, 542, 544, and 546, as well as a plurality of tabs 520, 522, 524, and 526. FIG. 15 is a perspective view of the one-piece, plastic-free package 501 where the rear portion 502 is folded to form a cavity 580 to hold a product, and is being folded over to fold onto the front support card 510. FIG. 16 is a rear view of the one-piece, plastic-free card 501 showing an assembled package 501. FIG. 17 is a front view of the one-piece, plastic-free package 501 showing an assembled package, where the cavity 580 is viewable through the window.

Although the invention has been discussed with reference to specific embodiments, it is apparent and should be understood that the concept can be otherwise embodied to achieve the advantages discussed. The preferred embodiments above have been described primarily as a one-piece, plastic-free blister package. In this regard, the foregoing description of the one-piece, plastic-free blister package is presented for purposes of illustration and description.

Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A one-piece, plastic-free blister package, the package comprising:
a one-piece card comprising:
a front support card,
a rear portion retained to the front support card, the rear portion configured for folding about and enclosing a product, the rear portion comprising:
a rectangular back;
a plurality of sidewalls foldably connected to and emerging away from the rectangular back, the plurality of sidewalls configured for offsetting the back portion from the front support card when folded; and,
a plurality of tabs, each of the plurality of tabs foldably connected to and emerging away from a corresponding sidewall of the plurality of sidewalls.

2. The one-piece, plastic-free blister package of claim 1, wherein the one-piece card is coated with blister coating.

3. The one-piece, plastic-free blister package of claim 2, wherein the blister coating is applied to a back surface of the one-piece card wherein the tabs of the rear portion are bonded to the front support card.

4. The one-piece, plastic-free blister package of claim 1, wherein the front support card further comprises a window for displaying a product.

5. The one-piece, plastic-free blister package of claim 1, wherein the one-piece card comprises cardstock in the range of approximately 14 point cardstock to approximately 28 point cardstock.

6. The one-piece, plastic-free blister package of claim 1, wherein the plurality of sidewalls is foldably connected to the back by a plurality of fold lines.

7. The one-piece, plastic-free blister package of claim 6, wherein each tab is foldably connected to a corresponding sidewall by a plurality of fold lines.

8. The one-piece, plastic-free blister package of claim 7, wherein the fold lines comprise one or more of a perforated line or a scored line.

9. The one-piece, plastic-free blister package of claim 1, wherein the package has no plastic components.

10. The one-piece, plastic-free blister package of claim 1, wherein the one-piece card has printing.

11. A one-piece, plastic-free blister package comprising:
a one-piece card comprising:
a front support card;
a rear portion retained to the support card, the rear portion comprising:
a rectangular back,
a first horizontal sidewall emerging vertically upward from the back, the first horizontal sidewall foldably connected to the back by a first horizontal foldable line;
a second horizontal sidewall emerging vertically downward from the back, the second horizontal sidewall foldably connected to the back by a second horizontal foldable line;
a first vertical sidewall emerging horizontally from the back toward the support card, the first vertical sidewall foldably connected to the back by a first vertical foldable line;
a second vertical sidewall emerging horizontally from the back in a direction away from the support card, the second vertical sidewall foldably connected to the back by a second vertical foldable line;
a first horizontal tab emerging vertically upward from the first horizontal sidewall, the first horizontal tab foldably connected to the first horizontal sidewall by a third horizontal foldable line;
a second horizontal tab emerging vertically downward from the second horizontal sidewall, the second horizontal tab foldably connected to the second horizontal sidewall by a fourth horizontal foldable line;
a first vertical tab foldably coupled to the first vertical sidewall and the support card, the first vertical tab foldably connected to the first vertical sidewall by a third vertical line, the first vertical tab foldably connected to the support card by a fourth vertical fold line; and,
a second vertical tab emerging horizontally from the second vertical sidewall in a direction further away from the support card, the second vertical tab foldably connected to the second vertical sidewall by a fifth vertical foldable line.

12. The one-piece, plastic-free blister package of claim 11, wherein the one-piece card is coated with blister coating.

13. The one-piece, plastic-free blister package of claim 12, wherein the blister coating is applied to a back surface of the one-piece card wherein the tabs of the rear portion are bonded to the front support card.

14. The one-piece, plastic-free blister package of claim 11, wherein the front support card further comprises a window for displaying a product.

15. The one-piece, plastic-free blister package of claim 11, wherein the one-piece card comprises cardstock in the range of approximately 14 point cardstock to approximately 28 point cardstock.

16. The one-piece, plastic-free blister package of claim 11, wherein the fold lines comprise one or more of a perforated line or a scored line.

17. The one-piece, plastic-free blister package of claim 11, wherein the package has no plastic components.

18. The one-piece, plastic-free blister package of claim 11, wherein the one-piece card has printing.

19. A method of making a one-piece, plastic-free package comprising a front support card and a rear portion, the rear portion comprising a back, a plurality of sidewalls, and a plurality of tabs, the method comprising:
printing onto a card;
applying a blister coating onto the card;
cutting the card to form a one-piece, plastic-free package;
folding a rear portion of a package to form a cavity to receive a product;
folding a front support card over the rear portion to form an enclosure for the package; and,
applying heat and pressure to the package for a specified time to bond a plurality of tabs of the rear portion to the front support card to form an assembled package.

20. The method of making the one-piece, plastic-free package comprising the front support card, the rear portion comprising the back, the plurality of sidewalls, and the plurality of tabs of claim 19, wherein the applying heat and pressure to the package with a specific sealing time to seal the tabs of the rear portion to the front support card further comprises:
applying the heat in the range of approximately 275 degrees to approximately 325 degrees Fahrenheit;
applying pressure of in the range of approximately 70 pounds per square inch of pressure to approximately 120 pounds per square inch of pressure; and,
applying the heat and pressure to the package for a time in the range of approximately 3 seconds to approximately 6 seconds.
